(19) United States
(12) Patent Application Publication
(10) Pub. No.: US 2022/0114005 A1
(43) Pub. Date: Apr. 14, 2022

(54) COMPARING TAGS FOR DETERMINING MATCHING VIRTUAL MACHINE IMAGES IN CLOUD NETWORKS

(71) Applicant: Hewlett Packard Enterprise Development LP, Houston, TX (US)

(72) Inventors: Balaji Ramamoorthi, Bangalore Karnataka (IN); Siva Subramaniam Manickam, Bangalore Karnataka (IN); Thavamaniraja Sakthivel, Bangalore Karnataka (IN); Vinnarasu Ganesan, Ponnamaravathy Tamilnadu (IN)

(21) Appl. No.: 17/302,004

(22) Filed: Apr. 21, 2021

(30) Foreign Application Priority Data
Oct. 12, 2020 (IN) 202041044306

(51) Int. Cl. G06F 9/455

(52) U.S. Cl. CPC G06F 9/45558; G06F 2009/45595

(57) ABSTRACT

Examples relate to comparing sets of tags for determining whether a VM image matches another VM image. Some examples generate a first set of tags corresponding to a first VM image that is to be created, compare a second set of tags corresponding to a second VM image available in an image store, with the first set of tags to determine whether the second VM image matches the first VM image, and send the result of the comparison to an image builder.

### BACKGROUND

Cloud computing, generally, involves delivery of computing as a service rather than a product, whereby shared computing resources (software, storage resources, networking resources, etc.) are provided as a service depending on the requirements of customers. The resources are shared over a network such as the internet. Cloud computing thus provides a quick and scalable access to computing resources and information technology (IT) services. One of the fundamental elements of cloud computing is virtualization, which helps in utilizing cloud computing in a scalable, economical and efficient manner.

### BRIEF DESCRIPTION OF THE DRAWINGS

These and other features, aspects, and advantages of the present specification will become better understood when the following detailed description is read with reference to the accompanying drawings in which like characters represent like parts throughout the drawings, wherein:

FIG. 1 is a block diagram of an example computing environment including a cloud network and a cloud management system for deploying and managing virtual machine (VM) images;

FIG. 2 is a sequence diagram showing an example process for deploying and managing a first VM image of a virtual machine available in a cloud network;

FIG. 3 is an example computing system including a processor and a machine-readable medium encoded with example instructions to deploy a VM image of a virtual machine available in a cloud network;

FIG. 4 is a flow diagram of an example method for determining whether a second VM image, available in a cloud management system of a cloud network, matches a first VM image of a virtual machine, which is to be deployed; and

FIG. 5 is a flow diagram of an example method for deploying a first VM image of a virtual machine available in a cloud network.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible.

The terminology used herein is for the purpose of describing particular examples only and is not intended to be limiting. As used herein, the singular forms “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected or associated, whether directly without any intervening elements or indirectly with at least one intervening element, unless otherwise indicated. Two elements can be connected mechanically, electrically, or communicatively linked through a communication channel, pathway, network, or system. The term “and/or” as used herein refers to and encompasses any and all possible combinations of the associated listed items. The term “based on” means based at least in part on. It will also be understood that, although the terms first, second, third, etc. may be used herein to describe various elements, these elements should not be limited by these terms, as these terms are only used to distinguish one element from another unless stated otherwise or the context indicates otherwise.

Cloud computing provides computational resources to an end-user (e.g., a customer), without the end-user setting up his own computing infrastructure in some cases. In cloud computing, cloud computing services may be provided by a cloud service provider over a cloud network (or a cloud). The cloud network may include a public cloud, a private cloud, or a hybrid cloud. To explain briefly, a cloud network may be termed as a public cloud if cloud computing services are rendered over a public network such as the internet. In a public cloud, the user typically pays only for what he uses. Examples of cloud service providers for public clouds include Amazon Web Services™, Rackspace™, and GoGrid™. On the other hand, a private cloud is a proprietary network that supplies services to a specific set of users. A hybrid cloud combines private and public cloud services.

As discussed, virtualization plays a significant role in delivering services, economically and efficiently, in cloud computing. Virtualization is creation of a virtual version of a resource such as an operating system, a hardware platform, a storage resource etc., which may be shared, for instance, among different clients at a time. With the help of virtualization, multiple virtual machines can run on a single machine (i.e., a host device) at the same time, hence increasing the utilization and flexibility of hardware.

Generally speaking, a virtual machine (VM) is a software implementation of a machine (i.e., a computer) that executes programs in a similar manner to a physical machine. Multiple VMs may run on a single computer hardware platform, which is also referred to as “host machine.” Although the VMs run in the same host machine, each VM has its own operating system and application programs, and functions as a computing environment separate from the host machine and the other VMs.

A cloud network may provide services to many different customers. To facilitate setup and use of a cloud computing service, cloud service providers offer pre-built virtual machine images (VM images) of the virtual machines, available in the cloud network, either from themselves or from a third party. A VM image refers to a binary image of a virtual machine, that may contain one or more virtual disk images. A VM image may be a data file that stores all information including an operating system, software, etc. for providing services in the cloud computing environment. A VM image of a virtual machine is, generally, deployed to provision an instance of the virtual machine. In some examples, a VM image may include an operating system and other software required to startup one or more simultaneous and active virtual machines.

A user may use a pre-built VM image from a catalog of VM images offered by a cloud service provider. A VM image may be offered for free, on lease, or to purchase, for example. A VM image listed in the catalog may be provided by the cloud service provider or a third-party, such as another user or a vendor. In some examples, a user may choose to install software, as needed, and create the VM image as his own. For example, the user may install additional software in a virtual machine and save the virtual machine as a virtual machine image. When a user deploys a VM image either from the catalog or a created VM image, that VM image becomes available in the user's catalog, that can be used for provisioning a virtual machine. The computing system may comprise a computing infrastructure including for example, a computing device and an interface, to allow the user to execute a VM image to boot an instance, i.e., startup a VM based on the VM image.

The catalog of VM images may include a list of various VM images provided from the cloud service provider or several users. However, VM images in the catalog may not be categorized or classified in a way that helps in identifying a VM image based on software contained therein. Further, since several VM images contains the same set of software on the same operating system, it may be challenging to identify which VM image contains what software, from the catalog. In some instances, users may manually classify the VM images for such identification, which may be a complex and tedious task to classify a VM image containing multiple software.

Examples described herein address these technological problems by generating tags, each identifying an application or a package to be included in a VM image of a virtual machine. Accordingly, a set of tags is generated corresponding to the VM image to be created. Wien the VM image is created, the set of tags that has been generated corresponding to the VM image is combined with a signature of the VM image and stored in a tag database. In some examples, when a request for creating a new VM image is received, a new set of tags corresponding to the new VM image is generated. The new set of tags is compared with each of the previously stored sets of tags that correspond to the previously stored VM images, to identify whether any previously stored VM image matches the new VM image. Accordingly, the examples described herein, help in identifying matching VM images, that contain matching applications and packages on the same operating system, which a user may deploy for provisioning a virtual machine rather than creating the new VM image. Identification of matching VM images aids in saving operational cost and reducing maintenance efforts by minimizing creation and storing of matching VM images.

As used herein, the term “matching VM images” may mean that a VM image matches another VM image when a match metric between a set of tags corresponding to the VM image and another set of tags corresponding to the other VM image is more than a threshold match metric. The match metric may be a metric that measures a number of tags that matches between the two sets of tags. The matching tags between the two sets of tags corresponding to two VM images may provide information about the applications and packages, contained or to be included in the VM images, that are the same.

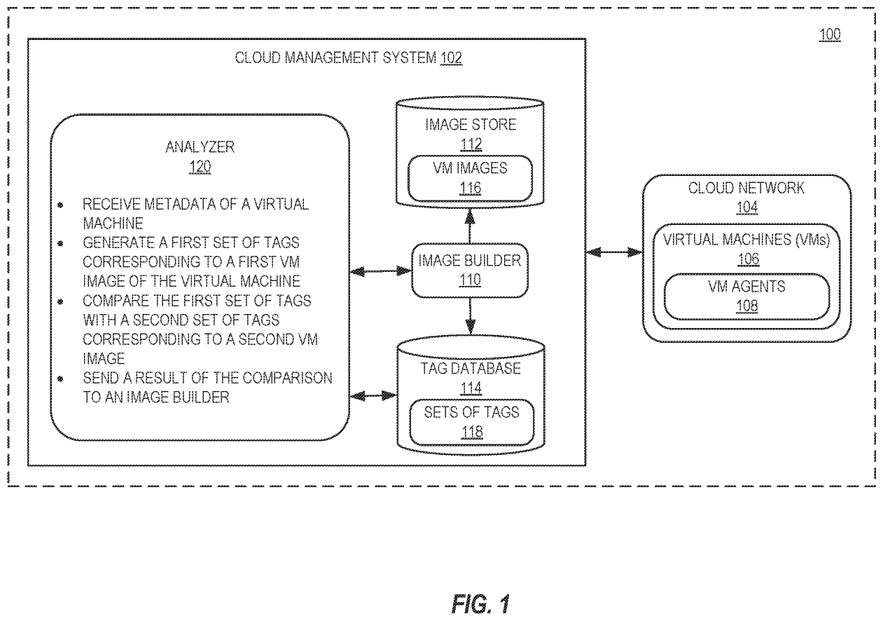

Examples are further described herein with reference to FIGS. 1-5. It should be noted that the description and figures merely illustrate the principles of the present subject matter along with examples described herein, and should not be construed as limiting the present subject matter. Furthermore, any functionality described herein as performed by a component (e.g., an image builder and an analyzer) of a cloud management system may be performed by at least one processor of the component executing instructions (stored on a machine-readable storage medium) to perform the functionalities described herein. Various implementations of the present subject matter have been described below by referring to several examples.

FIG. 1 is a block diagram of an example computing environment 100. The computing environment 100 may include a cloud management system 102 and a cloud network 104. Although a single cloud network 104 is shown in the computing environment 100 of FIG. 1, the computing environment 100 may include a plurality of cloud networks, in certain examples.

In an example, cloud management system 102 may be communicatively coupled with the cloud network 104. The cloud network 104 may be a wireless or wired network. The cloud network 104 may include, for example, a Local Area Network (LAN); a Wireless Local Area Network (WAN), a Metropolitan Area Network (MAN), a Storage Area Network (SAN), a Campus Area Network (CAN), or the like. Further, the cloud network 104 may be a public network (for example, the Internet) or a private network (for example, an intranet).

In an example, the cloud network 104 may include computing resources, network resources, and/or storage resources. Computing resources may include a hardware computing resource (e.g., includes at least one processor) or a software resource (e.g., including machine-executable instructions). In certain examples, the software resources may include virtual machines, virtual servers, load balancers, firewalls, etc. Network resources may include a network device, a network software, or any combination thereof. Some non-limiting examples of the network device may include a hub, a network switch, a network router, a virtual switch, and a virtual router. Storage resources may include a storage device, a storage software, or any combination thereof. Examples of the storage device may include a hard disk drive, a storage disc (for example, a CD-ROM, a DVD, etc.), a storage tape, a solid state drive, a USB drive, a Serial Advanced Technology Attachment (SATA) drive, a Fibre Channel (FC) drive, a Serial Attached SCSI (SAS) disk drive, a magnetic tape drive, an optical jukebox, and the like.

In an example, the cloud network 104 may be a public cloud, a private cloud, or a hybrid cloud. In a public cloud, cloud resources (like servers and storage) may be owned and operated by a third-party cloud service provider and delivered over a network (e.g., the Internet). In a public cloud, cloud resources may be shared with other organizations. On the other hand, in private cloud, cloud resources may be used exclusively by one organization.

In an example, the cloud network 104 may provide or deploy various types of cloud services. These services may include, for example, Infrastructure as a Service (IaaS), Platform as a Service (PaaS), and Software as a Service (SaaS).

Further, as discussed, virtualization may allow the creation of virtual machines in the cloud network 104. The virtual machines may be used for a variety of tasks, for example, to run multiple operating systems at the same time, or to test a new application on multiple platforms. A virtual machine may host an operating system, which may support software installed on that virtual machine. The software may include one or more packages and one or more applications. In certain examples, a virtual machine may include one or more packages and one or more applications installed on it.

In an example, the cloud network 104 includes a plurality of virtual machines 106. The virtual machines 106 may run on a host machine (e.g., a computing device). A user may use another computing device (e.g., a client computer) to connect to the host machine over the internet to access and use one or more of the virtual machines 106, In order to provision an instance of one of the VMs 106, the user may deploy a VM image of that virtual machine 106.

In an example, the cloud management system 102 may be used to manage resources such as computing resources, network resources, storage resources as well as the virtual machines 106 on the cloud network 104. In an example, one or more resources may be used by the cloud management system 102 to provide a cloud service (for example, IaaS) to a user. A user may use cloud management system 102 to request a new cloud service and manage an existing cloud service. Users may also use cloud management system 102 to view a status of a pending cloud service request, pending approvals, and approved service subscriptions.

The cloud management system 102 may include any combination of hardware and programming to implement the functionalities of the cloud management system 102 as described herein. In an example, the cloud management system 102 may be implemented as a program of instructions that may be read by and executed on a processing circuitry, which may include one or more processors and one or more dedicated hardware, to perform various functionalities described herein. In this context, “processor” refers to any circuitry capable of executing machine-readable instructions, such as a central processing unit (CPU), a microprocessor, a microcontroller device, a digital signal processor (DSP), etc. In examples in which the processing circuitry includes the processor(s) that are to execute machine-readable instructions, the machine-readable instructions may be stored in a memory. Memory may be a non-transitory, machine-readable medium including instructions that, when executed by the processor(s), cause the cloud management system 102 to undertake certain actions.

In an example, cloud management system 102 may represent any type of computing device capable of reading machine-executable instructions. Examples of the computing device may include, without limitation, a server, a desktop computer, a notebook computer, a tablet computer, a thin client, a mobile device, and the like.

The cloud management system 102 may be used to manage the deployment of VM images in the cloud network 104. As illustrated in FIG. 1, the cloud management system 102 may include an image builder 110, an image store 112, a tag database 114 and an analyzer 120. Any functionality described herein as performed by any component (e.g., the image builder 110 and the analyzer 120) of the cloud management system 102, may be performed by at least a processor executing instructions (stored on a machine-readable medium) to perform the functionalities as described herein.

The image builder 110 may be a service that is accessible by a user. When a user raises a request to create a VM image of a given virtual machine of the virtual machines 106, the image builder 110 may create the VM image based on the user's inputs and store the VM image in the image store 112. The image store 112 may be included in the memory of the cloud management system 102. In the examples described herein, prior to creating a VM image of the virtual machine 106, it is determined whether any previously stored VM image available in the image store 112, matches the VM image to be created.

In an example, on receiving a request to create the VM image of the virtual machine 106, the image builder 110 sends a request to a VM agent 108 to provide information of each application (i.e., constituent application) and each package installed on the virtual machine 106. The VM agent 108 may be a lightweight process running on the virtual machine 106, which is automatically installed on the virtual machine 106 during the provisioning of the virtual machine 106. In an example, each of the virtual machines 106 may include a VM agent 108. In response to the request from the image builder 110, the VM agent 108 collects information about each application and each package installed on the virtual machine 106 in the form of metadata of the virtual machine 106 and sends the metadata to the image builder 110. In some examples, the image builder 110 sends a request to the VM agent 108 to provide metadata of the virtual machine 106. The image builder 110 receives the metadata of the virtual machine 106 from the VM agent 108 and sends the metadata to the analyzer 120. In an example, the metadata of the virtual machine 106 includes a list of all the applications and all the packages installed on the virtual machine 106.

The analyzer 120 may comprise a processor-based system, device or apparatus that may enable the functionalities of the analyzer 120, as described herein. The analyzer 120 may instead be a service or application executing on one or more processor-based systems. In an example, the analyzer 120 may be implemented as a program of instructions that may be read by and executed on a processor.

On receiving the metadata of the virtual machine 106 from the image builder 110, the analyzer 120 may generate a set of tags corresponding to the VM image to be created based on the metadata of the virtual machine 106. In an example, the tags of the set of tags identify each application and each package to be included in the VM image to be created. In particular, the analyzer 120 identifies each application (i.e., constituent application) and each package installed on the virtual machine 106 from the metadata and automatically assigns each application and each package, individually, as a tag to generate the set of tags. That is, each tag of the set of tags identifies either an application or a package to be included in the VM image.

A tag, as used herein, may be a key-value pair, which describes the version of an application or a package contained or to be included in a particular VM image. In an example, a tag is a key-value pair that includes a name and a version of the application or the package. Accordingly, the tag identifies that application or that package. In an example, a set of tags may include multiple tags, each identifying an application or a package contained or to be included in a particular VM image. An example set of tags for a VM image may be as follows:

{″OS″: ″Ubuntu″ : { ″18.04″},
″Packages″ :{
″coreutils″: ″8.28″,
″cloud-guest-utils″: ″0.30″
“curl”:”7.58.0”
“mysql-server”:”5.7”

.
.
.

“apt-utils”:”1.6.3”
},
″services″: {
″mysql-server″: ″up″}
}

In this example set of tags, a tag for the operating system is “Ubuntu”: “18.4”, a tag for a package is “coreutils”: “8.28” and a tag for service is “mysql-server”: “up”.

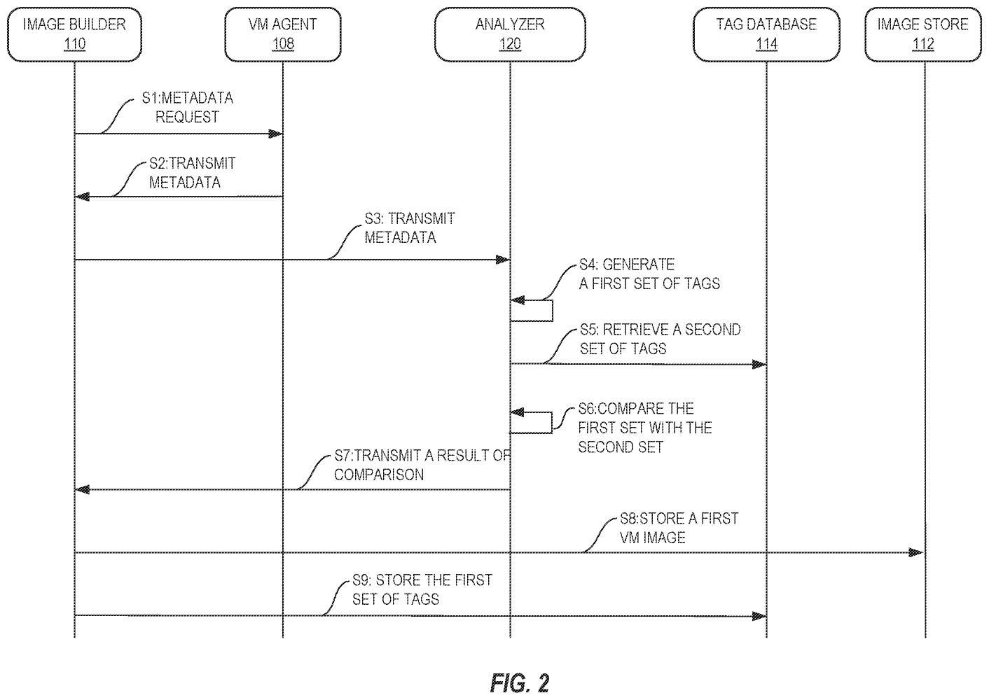

Once the set of tags are generated, the analyzer 120 may determine whether there is any other VM image, available in the image store 112 that matches the VM image to be created. The process of determining whether there is any VM image available in the image store 112 that matches the VM image to be created is described later below while describing FIG. 2.

In some examples, the analyzer 120 may determine that there is no VM image available in the image store 112 that matches the VM image to be created. In these examples, the analyzer 120 informs the image builder 110 that there is no other VM image available in the image store 112 that matches the VM image to be created. On receiving the information that there is no matching VM image available in the image store 112 that matches the VM image to be created, the image builder 110 creates the VM image of the virtual machine 106. In an example, the image builder 110 may install each application and each package, as needed to be included in the VM image to be created as per the user's inputs, in the virtual machine 106 and save the resulting virtual machine as the VM image in an image store 112. In addition, the image builder 110 computes a signature of the created VM image while or after creating the VM image.

As used herein, “signature” of a VM image may be a universally unique identifier (UUID). A universally unique identifier (UUID) may be a 128-bit number used to identify information in a computer system.

In the examples described herein, the image builder 110 stores the created VM image with its signature in the image store 112. In some examples, the image store 112 may include a plurality of VM images 116 along with their signatures. The plurality of VM images 116 may include VM images provided by a cloud service provider in the cloud network or other users.

Once the VM image is created, the image builder 110 receives the set of tags from the analyzer 120 and stores the set of tags corresponding to the created VM image in a tag database 114. The tag database 114 may be included in the memory of the cloud management system 102. The set of tags corresponding to the VM image to be created may refer to the set of tags associated with the signature of the created VM image. In an example, the image builder 110 combines the set of tags with the signature of the created VM image and stores the set of tags associated with the signature in the tag database 114. Table 1, below, shows an example set of tags associated with UUID, of an example VM image, stored in the tag database 114. Table 1 also includes a status of the example VM image in the image store 112 to identify whether the example VM image is in an active or error state. In some examples, if a process for creating the example VM image is successful, the resulting example VM image may be stored as in an active state. On the other hand, when the process of creating the example VM image is not successful, the resulting example VM image may be stored as in an error state.

TABLE 1
An example set of tags associated with UUID

| | | Status of |
|---|---|---|
| | | VM Image |
| | | in Image |
| VM Image UUID | Set of Tags | Store |
| 4c8593f1-659a-4e23-811f- | { | Active |
| 60d7cf4aed44 | ″OS″: ″Ubuntu″ : { ″18.04″}, | |
| | ″Packages″ : { | |

″coreutils″: ″8.28″,
″cloud-guest-utils″: ″0.30″
“curl”:”7.58.0”

.
.
.

“apt-utils”:”1.6.3”

```
  },
  ″services″: {
```

″mysql-server″: ″up″

}
}

In an example, the tag database 114 may include a plurality of sets of tags 118, each set corresponding to one of the VM images 116 stored in the image store 112.

In some examples, the analyzer 120 may determine that there are one or more other VM images that matches the VM image to be created. The analyzer 120 sends this information of the other VM image(s) that matches the VM image to be created to the image builder 110. The image builder 110 provides the information to the user. The user may decide to proceed or cancel the request of creating the VM image. In some instances, if the user cancels the request of creating the VM image, the image builder 110 does not create the VM image. The user may deploy one of the matching VM image(s). In other instances, if the user confirms to create the VM image, the image builder 110 proceeds to create the VM image. Once the VM image is created, the image builder 110 receives the set of tags from the analyzer 120 and stores the set of tags corresponding to the VM image in the tag database 114, as described above.

FIG. 2 is a sequence diagram showing a process of deploying a VM image (e.g., a first VM image) in the computing environment 100 of FIG. 1, in an example. First, in S1, a request (i.e., metadata request) to provide each application (i.e., constituent application) and each package installed on the virtual machine 106 is transmitted from the image builder 110 to the VM agent 108. The image builder 110 sends this metadata request to the VM agent 108 on receipt of a request to create a first VM image of one of the virtual machines 106. In response to the metadata request from the image builder 110, the VM agent 108 collects information about all the applications and packages installed on the virtual machine 106 in form of metadata of the virtual machine 106.

Next in S2, the metadata of the virtual machine 106 is transmitted to the image builder 110. Next in S3, the received metadata of the virtual machine 106 is transmitted by the image builder 110 to the analyzer 120. Next, in 54, on receiving the metadata, the analyzer 120 generates a first set of tags corresponding to the first VM image, as described previously. The first set of tags identifies each application and each package to be included in the first VM image. In an example, each tag of the first set of tags identifies an application or a package.

In order to determine whether a second VM image, that belongs to (and is pre-existing among) the plurality of VM images 116 available in the image store 112, matches the first VM image, the analyzer 120 compares the first set of tags with a second set of tags that corresponds to the second VM image available in the image store 112. The second set of tags corresponding to the second VM image was previously stored in the tag database 114 (in a similar fashion as described above and shown in Table 1) when the second VM image was created by the image builder 110. The second set of tags may belong to the plurality of sets of tags 118 stored in the tag database 114. The second set of tags identifies each application and each package contained in the second VM image. In particular, each tag of the second set of tags identifies an application or a package contained in the second VM image.

In the examples described herein, in S5, the analyzer 120 may retrieve the second set of tags associated with the signature of the second VM image from the tag database 114. Upon retrieving the second set of tags, in S6, the analyzer 120 compares the first set of tags with the second set of tags. In some examples, the analyzer 120 may determine whether the second set of tags includes a tag that matches a tag of the first set of tags. A tag of the second set of tags matches a tag of the first set of tags when the two tags identify the same application or the same package, and the two tags may be referred to as matching tags.

In some examples, as part of S6, the analyzer 120 may determine how many tags of the first set of tags match the tags of the second set of tags. Based on the comparison, the analyzer 120 may determine a match metric between the first set of tags and the second set of tags. A match metric between the first set of tags and the second set of tags may be a measure of a number of matching tags between the first set of tags and the second set of tags. The match metric may be a value, a percentage, a ratio and the like. In certain examples, the match metric may be percentage (i.e., match percentage) of the number of matching tags between the first set of tags and the second set of tags in a total number of tags in the first set of tags and the second set of tags. In some examples, a match metric between the first set of tags and the second set of tags may be, separately, determined for the tags identifying the packages (i.e., a match metric (packages)) and the tags identifying the applications (i.e., a match metric (applications)) in the first set of tags and the second set of tags. For example, a match percentage of tags identifying the packages between the first set of tags and the second set of tags may be determined as follows:

Match percentage (Packages)=(Number of matching tags identifying packages/Total number of tags identifying packages)×100

In an example, a match percentage of tags identifying the applications between the first set of tags and the second set of tags may be determined as follows:

Match percentage (Applications)=(Number of matching tags identifying applications/Total number of tags identifying applications)×100

On comparing the first set of tags with the second set of tags, the analyzer 120 may determine whether the second VM image matches the first VM image and thereby provide a result of the comparison. In an example, the determination is made based on the match metric. In some examples, the match metric is compared with a threshold match metric. A threshold match metric may be a match metric value predefined by the user to set a criteria to determine whether two VM images match each other. For example, if the user defines a threshold match metric as 90 percent, two VM images are determined to be matching if the match metric between their sets of tags is more than 90 percent.

In examples where the match metric (package) and the match metric (applications) are determined, the match metric (packages) is compared with a threshold match metric (packages) predefined by a user and the match metric (applications) is compared with a threshold match metric (applications) predefined by the user.

On comparing the match metric and the threshold match metric, the analyzer 120 may determine whether the match metric is more than the threshold match metric in order to determine whether the second VM image matches the first VM image. In some examples, when the match metric between the first set of tags and the second set of tags is not more than the threshold match metric, it is determined that the second VM image does not match the first VM image. In some examples, when the match metric is more than the threshold match metric, it is determined that the second VM image matches the first VM image.

In some examples, the analyzer 120 may retrieve all the sets of tags 118, corresponding to the respective VM images 116, from in the tag database 114 and compare each set of tags of the sets 118 with the first set of tags. On comparing, the analyzer 120 determines whether any VM image of the VM images 116 matches the first VM image. In some examples, the result of the comparison may be negative when none of the VM images 116 matches the first VM image. In some other examples, the result of the comparison may be positive when one or more VM images of the VM images 116 match the first VM image.

Next in S7, the result of the comparison is transmitted to the image builder 110. In an example, the analyzer 120 sends the result of the comparison to the image builder 110. In the examples when the result is positive, the analyzer 120 sends information indicating that the VM image(s) match the first VM image. In an example, the analyzer 120 may send a list of signatures of the VM image(s) that match the first VM image to the image builder 110. In certain examples, the analyzer 120 sends the signature of the second VM image to the image builder 110. Further, the analyzer 120 may send additional information including the match metric between the first set of tags and the second set of tags and information about different tags (that do not match any tag) of the first set of tags and the second set of tags. Such different tags may provide information about one or more applications or packages contained in the second VM image that are different from that of to be included in the first VM image or one or more applications or packages to be included in the first VM image that are not contained in the second VM image.

The image builder 110 receives the result of the comparison from the analyzer 120. In some examples when the result is negative, the image builder 110 proceeds to create the first VM image.

In some examples when the result is positive, the image builder 110 provides the result of the comparison to the user. The user may decide to proceed or cancel the request of creating the first VM image. The image builder 120 may proceed to create the first VM image based on an input from the user. In some instances, if the user cancels the request of creating the first VM image, the image builder 110 does not create the first VM image. The user may deploy one of the matching VM images (e.g., the second VM image). In other instances, if the user confirms to create the first VM image, the image builder 110 proceed to create the first VM image.

On creating the first VM image, the image builder 110 computes the signature of the first VM image and store the first VM image along with the signature in the image store 112, in S8. Further, the image builder 110 receives the first set of tags from the analyzer 120, combines the first set of tags with the signature of the first VM image, and stores the first set of tags associated with the signature in the tag database 114, in 39, as described previously. The image builder 110 also sends image information (e.g., an image name, UUID, address and size of the first VM image) related to the created first VM image to the user.

As will be appreciated, the techniques, as described herein, may reduce creation of matching VM images in a cloud network. Reduction in the creation of VM images may, in turn, contribute to savings in the overall storage operational cost and also reduce overhead for an administrator during maintenance and while performing updates. In addition, the techniques enable users to find VM images that match the users' requirements depending on selected packages and applications. This provides flexibility to users to identify a pre-created VM image for end use purpose.

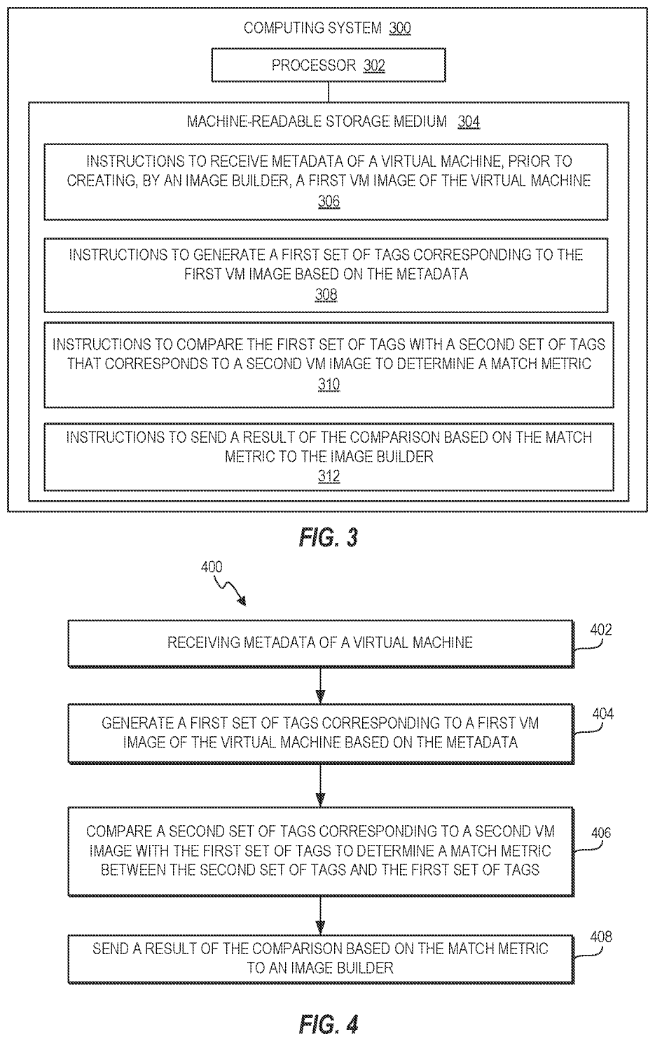

FIG. 3 is a block diagram 300 of a computing system 300 including a processor 302 and a machine-readable storage medium 304 encoded with example instructions 306, 308, 310 and 312 (306-312) to deploy a VM image in a cloud network (e.g., the cloud network 104 of FIG. 1), in accordance with an example. The instructions 306-312 of FIG. 3, when executed by the processor 302, may implement some or all functions of an analyzer (e.g., the analyzer 120 of FIG. 1). In some examples, the computing system 300 may be included in (e.g., as part of) the analyzer 120 of FIG. 1.

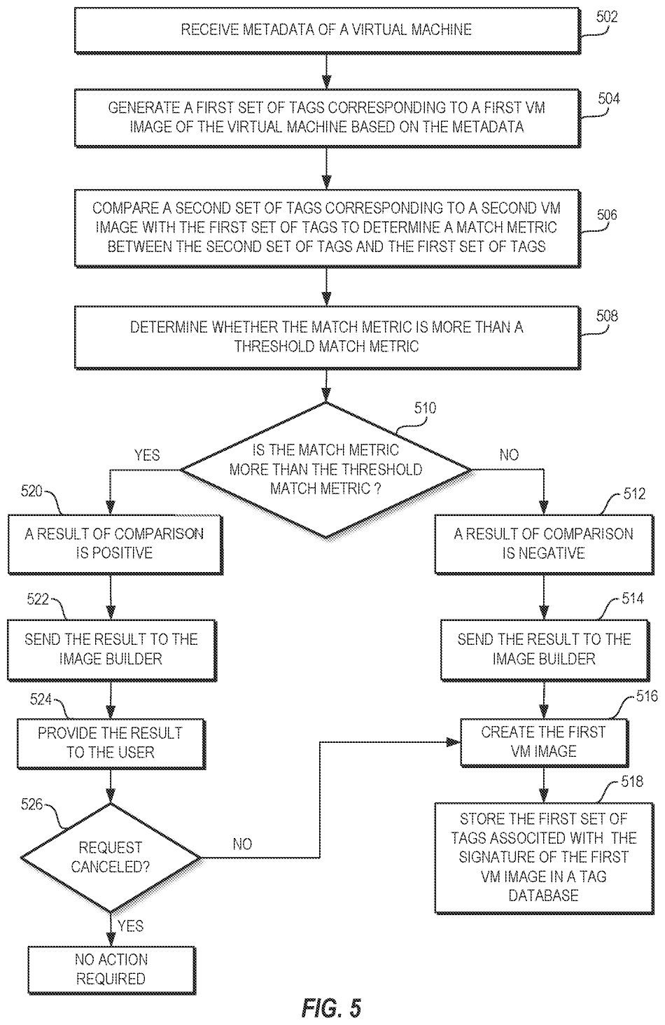

For ease of illustration, FIG. 3 is described with reference to FIGS. 1 and 2. In certain examples, the instructions 306-312 may be executed for performing the functionalities of the analyzer 120 or one or more methods, such as, the methods 400 and 500 described in FIGS. 4 and 5. In certain examples, as an alternative or in addition to executing the instructions 306-312, the processor 302 may include at least one integrated circuit, other control logic, other electronic circuitry, or combinations thereof that include a number of electronic components for performing the functionalities described herein as being performed by the analyzer 120.

Instructions 306, when executed by the processor 302, may receive the metadata of the virtual machine 106 from the image builder 110. In an example, when the image builder 110 receives the request to create a first VM image of the virtual machine 106 from a user, the image builder 110 requests the VM agent 108 to provide information of each application and each package installed on the virtual machine 106. The image builder 110 receives metadata of the virtual machine 106 from the VM agent 108, in response to the request, and sends the metadata to the analyzer 120.

Instructions 308, when executed by the processor 302, may generate the first set of tags corresponding to the first VM image based on the received metadata. The first set of tags identifies each application and each package to be included in the first VM image.

Instructions 310, when executed by the processor 302, may compare the first set of tags with a second set of tags corresponding to a second VM image that belongs to the plurality of VM images 116 stored in the image store 112. In some examples, the instructions 310 may further include instructions, when executed by the processor 302, to retrieve the second set of tags corresponding to the second VM image from the tag database 114 and compare the retrieved second set of tags with the first set of tags. In an example, the instructions 310 may further include instructions, when executed by the processor 302, to determine a match metric between the first set of tags and the second set of tags.

Instructions 312, when executed by the processor 302, may send a result of the comparison based on the match metric to the image builder 110. In some examples, the instructions 312 may include instructions, when executed by the processor 302, to determine whether the match metric is more than a threshold match metric to determine whether the second VM image matches the first VM image. In some examples, when the match metric is more than the threshold match metric, it is determined that the second VM image matches the first VM image. In some examples, it is determined that one or more VM images of the VM images 116 stored in the image store 112 match the first VM image. In these instances, the result of the comparison is positive and includes the VM image(s) that match the first VM image. In some examples, when the match metric is not more than the threshold match metric, it is determined that the second VM image does not match the first VM image. In some examples, it is determined that none of the VM images 116 stored in the image store 112 matches the first VM image. In these examples, the result of the comparison is negative, and indicates that no VM image matches the first VM image.

The instructions 306-312 may include various instructions to execute at least a part of the methods described in FIGS. 4 and 5 (described later). Also, although not shown in FIG. 3, the machine-readable storage medium 304 may also include additional program instructions to perform various other method blocks described in FIGS. 4 and 5.

FIGS. 4 and 5 depict flowcharts of example methods 400 and 500 for deploying VM images in a computing environment (e.g., the computing environment 100 of FIG. 1) including a cloud network. For illustration purposes, the execution of examples methods 400 and 500 is described in conjunction with FIGS. 1 and 2. Although the below description is described with reference to the analyzer 120 of FIG. 1, other applications or devices suitable for the execution of methods 400 and 500 may be utilized. In some examples, the methods 400 and 500, individually, at each method blocks may be executed by the computing system 300 (FIG. 3) via the processor 302 that executes the instructions 306-312 stored in the non-transitory machine-readable storage medium 304. Additionally, implementation of methods 400 and 500 is not limited to such examples. Although the flowcharts of FIGS. 4 and 5, individually, show a specific order of performance of certain functionalities, methods 400 and 500 are not limited to such order. For example, the functionalities shown in succession in the flowcharts may be performed in a different order, may be executed concurrently or with partial concurrence, or a combination thereof.

Referring to FIG. 4, in block 402, the analyzer 120 may receive the metadata of the virtual machine 106 from the image builder 110. In an example, the analyzer 120 receives the metadata from the image builder 110 in response to the request from a user to create the first VM image of the virtual machine 106. On receipt of the request from the user, the image builder 110 requests the VM agent 108 to provide information of each application and each package installed on the virtual machine 106. In response to the request, the image builder 110 receives the metadata from the VM metadata agent 108, and then sends the metadata to the analyzer 120.

In block 404, the analyzer 120 may generate the first set of tags corresponding to the first VM image based on the metadata of the virtual machine 106. In an example, the analyzer 120 identifies each application and each package, installed on the virtual machine 106, from the metadata of the virtual machine 106 and generates a tag for each application or each package. Accordingly, each tag of the first set of tags may identify an application or a package to be included in the first VM image.

In block 406, the first set of the tags is compared with a second set of tags corresponding to a second VM image of the VM images 116 available in the image store 112. In an example, the analyzer 120 retrieves the second set of tags corresponding to the second VM image from the tag database 114 and compare the retrieved second set of tags with the first set of tags. On comparing the first set of tags and the second set of tags, a match metric (described above) between the first set of tags and the second set of tags is determined. Additional details of comparing the first set of tags and the second set of tags and determining the match metric are described with respect to FIGS. 1 and 2.

In block 408, a result of the comparison is sent to the image builder 110. The result of the comparison may be determined based on the match metric. In some examples, in order to determine whether the second VM image matches the first VM image, it may be determined whether the match metric is more than the threshold match metric. In some examples, when the match metric is more than the threshold match metric, the second VM image matches the first VM image. In some examples, it is determined that one or more VM images of the VM images 116 stored in the image store 112 match the first VM image. In these instances, the result of the comparison is positive and includes the VM image(s) that match the first VM image. In some examples, when the match metric is not more than the threshold match metric, it is determined that the second VM image does not match the first VM image. In some examples, it is determined that none of the VM images 116 stored in the image store 112 matches the first VM image. In these examples, the result of the comparison is negative, and indicates that no VM image matches the first VM image.

Turning now to FIG. 5, the method 500 includes certain blocks that are similar to one or more blocks described in FIG. 4, details of which are not repeated herein for the sake of brevity. By way of example, the blocks 502, 504 and 506 of FIG. 5 are similar to blocks 402, 404 and 406, respectively, of FIG. 4.

In block 502, the metadata of the virtual machine 106 is received, by the analyzer 120, from the image builder 110. In block 504, the first set of tags corresponding to the first VM image (that is to be created) of the virtual machine 106 is generated based on the metadata of the virtual machine 106. In block 506, the first set of the tags is compared with the second set of tags of the second VM image available in image store 112. The second set of tags is retrieved from the tag database 114, and compared with the first set of tags. On comparing the first set of tags with the second set of tags, a match metric (described above) between the first set of tags and the second set of tags is determined.

In block 508, it is determined whether the match metric is more than the threshold match metric (described above) to identify whether the second VM image matches the first VM image. In some examples, when the match metric is not more than the threshold match metric (NO′ at block 510), it is determined that the second VM image does not match the first VM image. In some examples, it may be determined that none of the VM images 116 stored in the image store 112 matches the first VM image. In these instances, a result of the comparison is negative, in block 512.

In block 514, the negative result of the comparison is sent to the image builder 110. On receiving the result that none of the VM images 116 matches the first VM image, in block 516, the image builder 110 creates the first VM image. On creating the first VM image, the image builder 110 generates the signature of the first VM image and store the first VM image along with the signature in the image store 112.

In block 518, the image builder 110 combines the first set of tags with the signature of the first VM image, and store the first set of tags associated with the signature of the first VM image in the tag database 114.

In some examples, when the match metric is more than the threshold match metric (‘YES’ at block 510), it is determined that the second VM image matches the first VM image. In some examples, it is determined that one or more VM images of the VM images 116 match the first VM image. In these instances, the result of the comparison is positive, in block 520. The method 500 proceeds to block 522.

In block 522, the positive result of the comparison is sent to the image builder 110. In an example, a signature of the second VM image is sent to the image builder 110 to indicate that the second VM image matches the first VM image. Further, additional information including the match metric between the first VM image and the second VM image, and information about the difference(s) in the application(s) and package(s) of the first VM image and second VM image may be sent to the image builder 110. In some other examples, when one or more VM images that match the first VM image are determined, a list of the signatures of the respective VM image(s) along with the additional information is sent to the image builder 110.

In block 524, the image builder 110 provides the positive result of the comparison to the user. In some instances, the image builder 110 provide the list of signatures of the VM image(s) along with the additional information to the user. Based on the received information, the user may cancel or proceed with the request of creating the first VM image.

In some examples, the user may cancel the request of creating the first VM image (YES' at block 526). In such examples, the image builder 110 does not create the first VM image. The image builder 110 may cancel the process of creating the first VM image. No further action may be required. The user may deploy one of the VM image(s) (e.g., the second VM image) that match the first VM image. In other examples, the user may confirm to proceed with the request of creating the first VM image (‘NO’ at block 526). In such examples, the image builder 110 proceeds with the request to create the first VM image. The method proceeds to blocks 516 and 518. The method follows the process of creating the first VM image as described in blocks 516 and 518.

In examples described herein, functionalities described as being performed by “instructions” may be understood as functionalities that may be performed by those instructions when executed by a processor. In other examples, functionalities described in relation to instructions may be implemented by one or more systems or components, which may be any combination of hardware and programming to implement the functionalities of the system(s) or component(s).

As used herein, a “computing system” may be a server, storage device, storage array, desktop or laptop computer, switch, router, or any other processing device or equipment including a processor. In examples described herein, a processor may refer to one processor or multiple processors included in a single computing device or distributed across multiple computing systems. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. In examples described herein, a processor may fetch, decode, and execute instructions stored on a storage medium to perform the functionalities described in relation to the instructions stored on the storage medium. In other examples, the functionalities described in relation to any instructions described herein may be implemented in the form of electronic circuitry, in the form of executable instructions encoded on a machine-readable storage medium, or a combination thereof. The storage medium may be located either in the computing system executing the machine-readable instructions, or remote from but accessible to the computing system (e.g., via a computer network) for execution. In the examples illustrated in FIGS. 1 and 2, the analyzer 120 and the image builder 110 may be implemented by one machine-readable storage medium, or multiple machine-readable storage media.

As used herein, a “machine-readable storage medium” may be any electronic, magnetic, optical, or other physical storage apparatus to contain or store information such as executable instructions, data, and the like. For example, any machine-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any machine-readable storage medium described herein may be non-transitory. In examples described herein, a machine-readable storage medium or media may be part of an article (or article of manufacture). All of the features disclosed in this specification (including any accompanying claims, abstract and drawings), and/or all of the elements of any method or process so disclosed, may be combined in any combination, except combinations where at least some of such features and/or elements are mutually exclusive.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

We/I claim:

1. A method comprising:
receiving, by a processor-based analyzer, metadata of a virtual machine available in a cloud network, prior to creating, by an image builder, a first virtual machine (VM) image of the virtual machine;
generating, by the analyzer, a first set of tags corresponding to the first VM image based on the metadata, wherein the first set of tags identifies each package and each application to be included in the first VM image;
comparing, by the analyzer, a second set of tags with the first set of tags, wherein the second set of tags corresponds to a second VM image available in an image store and identifies each package and each application contained in the second VM image; and
sending, by the analyzer, a result of the comparison to the image builder.

2. The method of claim 1, wherein receiving comprises receiving the metadata of the virtual machine from the image builder.

3. The method of claim 2, further comprising:
sending, by the image builder, a request, to a virtual machine agent of the virtual machine, to provide information about each package and each application installed on the virtual machine;
in response to the request, receiving, by the image builder, the metadata of the virtual machine from the virtual machine agent; and
sending, by the image builder, the metadata of the virtual machine to the analyzer.

4. The method of claim 1, wherein:
each tag of the first set of tags identifies an application or a package to be included in the first VM image; and
each tag of the second set of tags identifies an application or a package contained in the second VM image.

5. The method of claim 1, further comprising retrieving the second set of tags from a tag database.

6. The method of claim 1, wherein comparing further comprises:
determining a match metric between the first set of tags and the second set of tags based on a number of tags that matches between the first set of tags and the second set of tags; and
determining whether the match metric is more than a threshold match metric.

7. The method of claim 6, wherein the match metric is a percentage of the number of tags that matches between the first set of tags and the second set of tags in a total number of tags in the first set of tags and the second set of tags.

8. The method of claim 6, wherein the result of the comparison comprises information identifying that the second VM image matches the first VM image, in response to determining that the match metric is more than the threshold match metric.

9. The method of claim 1, wherein sending the result of the comparison further comprises sending additional information including a match metric and information about a difference between the first set of tags and the second set of tags.

10. The method of claim 8, further comprising:
upon receiving the result of the comparison from the analyzer, providing, by the image builder, the result of the comparison to the user;
in response to receiving instructions, from the user, to create the first VM image, creating, by the image builder, the first VM image;
upon creating the first VM image, generating, by the image builder, a signature of the first VM image;
combining, by the image builder, the signature with the first set of tags received from the analyzer; and
storing the first set tags associated with the signature in a tag database.

11. The method of claim 6, wherein the result of the comparison comprises information identifying that the second VM image does not match the first VM image, in response to determining that the match metric is not more than the threshold match metric.

12. The method of claim 11, further comprising:
upon receiving the result of the comparison from the analyzer, creating, by the image builder, the first VM image;
upon creating the first VM image, generating, by the image builder, a signature of the first VM image;
combining, by the image builder; the signature with the first set of tags received from the analyzer; and
storing, by the image builder, the first set tags associated with the signature in a tag database.

13. A non-transitory machine-readable medium storing instructions that, when executed by a processor, cause the processor to:
receive metadata of a virtual machine available in a cloud network, prior to creating, by an image builder, a first virtual machine (VM) image of the virtual machine;
generate a first set of tags corresponding to the first VM image based on the metadata, wherein the first set of tags identifies each package and each application to be included in the first VM image;
compare a second set of tags with the first set of tags to determine a match metric between the first set of tags and the second set of tags, wherein the second set of tags corresponds to a second VM image available in an image store and identifies each package and each application contained in the second VM image; and
send a result of the comparison to the image builder based on the match metric.

14. A cloud management system comprising:
an image builder to receive a request to create a first virtual machine (VM) image of a virtual machine available in a cloud network; and
an analyzer comprising a processor and a machine-readable medium storing instructions that, when executed by the processor, cause the processor to:
receive metadata of the virtual machine, by an image builder, prior to creating the first VM image of the virtual machine,
generate a first set of tags corresponding to the first VM image based on the metadata, wherein the first set of tags identifies each package and each application to be included in the first VM image,
compare a second set of tags with the first set of tags, wherein the second set of tags corresponds to a second VM image available in an image store and identifies each package and each application contained in the second VM image, and
send a result of the comparison to the image builder.

15. The cloud management system of claim 14, wherein:
each tag of the first set of tags identifies an application or a package to be included in the first VM image, and
each tag of the second set of tags identifies an application or a package contained in the second VM image.

16. The cloud management system of claim 14, wherein the machine-readable medium stores further instructions that, when executed by the processor, cause the processor to:
retrieve the second set of tags from a tag database to compare the second set of tags with the first set of tags.

17. The cloud management system of claim 14, wherein the instructions to compare further comprise instructions to:
determine a match metric between the first set of tags and the second set of tags based on a number of tags that matches between the first set of tags and the second set of tags, and
determine whether the match metric is more than a threshold match metric.

18. The cloud management system of claim 17, wherein the match metric is a percentage of the number of tags that matches between the first set of tags and the second set of tags in a total number of tags in the first set of tags and the second set of tags.

19. The cloud management system of claim 17, wherein the result of the comparison comprises information identifying that the second VM image matches the first VM image when the match metric is more than the threshold match metric.
